(19) United States
(12) Patent Application Publication
(10) Pub. No.: US 2005/0286353 A1
(43) Pub. Date: Dec. 29, 2005

(54) Optical disc apparatus

(75) Inventor: Masaaki Hanano, Kitakatsuragi-gun (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/166,745

(22) Filed: Jun. 23, 2005

(30) Foreign Application Priority Data
Jun. 24, 2004 (JP) 2004-186946

(51) Int. Cl. G11B 7/00

(52) U.S. Cl. 369/44.13; 369/124.01; 369/53.1

(57) ABSTRACT

The present invention provides an optical disc apparatus including a clock generator means which is not affected by an unsteady wobble signal generated immediately after starting recording but follows the wobble signal even when decentering, etc. occur. The optical disc apparatus of the present invention includes (i) an amplification head capable of amplifying an extracted wobble signal at the time of recording with an amplification degree lower than that at the time of non recording, the extracted wobble signal being read out from a wobbling formed on an optical disc, (ii) an AGC for performing gain control so that an amplitude of the amplified wobble signal outputted from the amplification head reaches a target value, and (iii) a PLL capable of causing the wobble clock to follow the extracted wobble signal by a shift width proportional to the amplitude of the gain control wobble signal outputted from the AGC.

This Nonprovisional application claims priority under 35 U.S.C. § 119(a) on Patent Application No. 2004/186946 filed in Japan on Jun. 24, 2004, the entire contents of which are hereby incorporated by reference.

### FIELD OF THE INVENTION

The present invention relates to an optical disc apparatus, and more particularly to an optical disc apparatus provided with a clock generator means applicable to a disc drive apparatus which carries out recording and reproduction with respect to a disc recording medium, such as an optical disc.

### BACKGROUND OF THE INVENTION

In recent years, various optical discs that can record and reproduce data have been proposed. Concrete examples of such optical discs are CD-R (Compact Disc−Recordable), CD-RW (Compact Disc−ReWritable), DVD-R (Digital Versatile Disc−Recordable), DVD−RW (Digital Versatile Disc−ReWritable), DVD+RW (Digital Versatile Disc+ReWritable), etc.

In order to record data, these optical discs have grooves thereon as data tracks for data recording.

The grooves are so formed as to wind in a constant cycle (wobbling), and it is possible to read out a wobble signal from the wobbling. The wobble signal is used to generate a recording clock.

That is, an optical disc recording/reproducing apparatus (optical disc apparatus) includes a PLL (Phase Locked Loop) for oscillating the recording clock, and the wobble signal is used as a reference for adjusting the recording clock. That is, in the PLL, (i) a wobble clock synchronized with the wobble signal is generated, (ii) the wobble clock is multiplied so that the recording clock is generated, and (iii) based on the recording clock, data recording is carried out. Thus, the recording clock is generated based on the wobble signal, so that it is necessary to detect the wobble signal accurately.

However, as indicated by a wobble signal S₁₄ in FIG. 9, generally, after switching from a reproducing operation to a recording operation, a wavelength of the wobble signal becomes unsteady in a certain period (in a period from a switching time point T1 to a switching time point T2 in FIG. 9), that is, in a period during which a laser power for irradiating the optical disc is being switched. A binarized signal S₁₅ is a signal obtained by binarizing the wobble signal. According to this, because the wobble signal becomes unsteady immediately after the start of the recording, the binarized signal is also unsteady. On this account, there is a problem in that the recording clock generated by using the binarized signal is also unsteady. In order to solve the above problems, one countermeasure is disclosed in Japanese Laid-Open Patent Publication No. 2001-118244 (Tokukai 2001-118244, published on Apr. 27, 2001). The following schematically explains a technique disclosed in the publication.

First, as indicated by a wobble enable signal S16, the wobble enable signal shows a low voltage value “L” in a certain period (in a period from T0 to T3) starting from immediately before the time point T1 that is a time point of switching from the reproducing operation to the recording operation. Then, the PLL for generating clocks is so arranged as to get the wobble signal only when the wobble enable signal shows the high voltage value “H” and ignore an input of the wobble signal when the wobble enable signal is “L”. That is, the wobble signal is ignored before and after a time point of switching from the reproducing operation to the recording operation, and an output for a phase comparison is put on hold.

In this way, the wobble signal whose wavelength is unsteady immediately after the start of the recording is ignored, so that the wobble clock does not become unsteady.

However, the above technique has the following problems.

Generally, the optical disc allows for a center deviance in a certain range at the time of manufacture. Moreover, in the optical disc apparatus, there is surely an axis center deviance of, for example, a spindle motor. On this account, even during one rotation of the disc, a distance from a center of the rotation to a portion where a laser light is irradiated varies. That is, a linear velocity of the portion where the laser light is irradiated varies according to decentering, and therefore, a frequency of the wobble signal to be reproduced also varies. Moreover, there is a possibility that, due to disturbances applied to the optical disc apparatus, the rotation of the motor becomes unstable and therefore the frequency of the wobble signal varies.

However, the PLL described in the above publication is so arranged as to (i) ignore the inputted wobble signal in a period (in a period from the time point T0 to the time point T3) of switching from the reproducing operation to the recording operation and (ii) works by itself. On this account, in a period from the time point T1 to the time point T3 (an actual recording starts from the time point T1), that is, in a portion of the start of the data recording, the recording is carried out by using the recording clock which is not synchronized with the rotation of the disc. Normally, the portion of the start of the data recording is important as a portion in which the PLL used for reproduction start working so as to cause the wobble clock to synchronize with the wobble signal in order to extract at the time of reproduction the wobble clock synchronized with recorded data. Therefore, in the case in which the data is recorded by a PLL clock which is not synchronized with the disc, there is a possibility that the data cannot be reproduced.

Therefore, it is desirable that the optical disc apparatus satisfies the following antithetical requirements: (i) the optical disc apparatus follows variations in the linear velocity caused by the decenterings or the disturbances and (ii) the optical disc apparatus is almost never affected by the unsteady wobble signal obtained immediately after the start of the recording.

### SUMMARY OF THE INVENTION

The present invention was made to solve the above problems, and an object of the present invention is to provide an optical disc apparatus provided with a clock generator means which (i) is almost never affected by the unstable wobble signal obtained at the time of the start of the recording and (ii) can follow frequency variations of the wobble signal, the frequency variations being caused due to (a) the decentering of the disc, (b) the decentering of the spindle motor of the optical disc apparatus, (c) the disturbances, or the like.

In order to solve the above problems, an optical disc apparatus of the present invention includes (i) an amplifier means for amplifying an extracted wobble signal at the time of recording with an amplification degree lower than that at the time of non recording, the extracted wobble signal being read out from a wobbling formed on an optical disc, (ii) an automatic gain control means for performing gain control so that an amplitude of the amplified wobble signal amplified by the amplifier means reaches a predetermined target value after a predetermined period has passed, so as to output a gain control wobble signal, and (iii) a clock generator means capable of generating a wobble clock which is so corrected by a shift width proportional to the amplitude of the gain control wobble signal as to follow the extracted wobble signal.

Note that, the above expression “follow the extracted wobble signal” indicates that the phase of the wobble clock is changed so as to synchronize with the extracted wobble signal.

According to the above arrangement, the extracted wobble signal read out from the wobbling is amplified at the time of recording with the amplification degree lower than that at the time of non recording. That is, at the time of the start of the recording, the amplitude of the amplified wobble signal inputted to the automatic gain control means steeply decreases. The automatic gain control means performs the gain control so that the amplitude of the amplified wobble signal reaches the target value after the predetermined period has passed. Therefore, immediately after switching from the time of non recording to the time of recording (immediately after the start of the recoding), the amplitude is very low. That is, the gain control wobble signal is lower than the target value until the automatic gain control means performs the gain control according to the change in the amplitude of the amplified wobble signal, that is, until the gain control wobble signal completely reaches the target value. Therefore, the amplitude of the gain control wobble signal is low only immediately after the start of the recording.

Further, the wobble clock generated by the clock generator means is so corrected by a shift width proportional to the amplitude of the gain control wobble signal as to become close to the phase of the extracted wobble signal. Therefore, immediately after the start of the recording, the wobble clock is so corrected as to follow the extracted wobble signal at a low rate.

Therefore, the wobble clock follows, at a low rate, the extracted wobble signal which is most likely unsteady immediately after the start of the recording, but correctly follows, at a higher rate, the extracted wobble signal after the gain control wobble signal has reached the target value.

Moreover, the clock generator means can generate the wobble clock which has followed the extracted wobble signal immediately after the start of the recording even though a rate of correction is low. Therefore, the clock generator means can cause the wobble clock to follow the frequency of the wobble signal even when the frequency changes due to the decentering, disturbances, or the like immediately after the start of the recording.

According to the above, the present invention achieves an effect in which (i) the wobble clock follows the extracted wobble signal while reducing an influence of the unsteady extracted wobble clock obtained immediately after the start of the recording, and (ii) the wobble clock can follow the extracted wobble signal in the same way as before even when any change in the extracted wobble signal occurs in a period other than the above.

Note that, the above expression “a predetermined period” may be determined for each optical disc apparatus as an arbitrary period at least including a period during which the extracted wobble signal is greatly unsteady. Moreover, the above expression “a predetermined target value” may also be determined for each optical disc apparatus as an amplitude of the extracted wobble signal which can be followed in the same way as usual by using the clock generator means. In addition, a method of causing the amplitude of the wobble signal to reach the predetermined target value after the predetermined period has passed is that, for example, (i) the gain is so set that the amplitude stepwisely changes until it reaches the target value or (ii) the amplitude is amplified after the predetermined period has passed.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 shows an embodiment of the present invention, and is a block diagram showing an arrangement of an optical disc apparatus.

FIG. 2 shows the embodiment of the present invention, and is a block diagram showing an arrangement of an amplification head of the optical disc apparatus.

FIG. 3 shows the embodiment of the present invention, and is a block diagram showing an arrangement of an AGC of the optical disc apparatus.

FIG. 4 shows the embodiment of the present invention, and is a diagram showing a state of an indicial response in the case in which the ACG is constituted of a first-order lag element.

FIG. 5 shows the embodiment of the present invention, and is a block diagram showing an arrangement of a PLL 6 shown in FIG. 1.

FIG. 6 shows the embodiment of the present invention, and is a diagram showing output waveforms of an amplifier means 4 and an AGC 5 immediately before and after the start of a recording operation.

FIG. 7 shows the embodiment of the present invention, and is a diagram showing waveforms of input/output signals of blocks in the clock generator means shown in FIG. 5 in the case in which the phase of the wobble clock is advanced 30 degrees from that of the wobble signal. A digital wobble signal S₄ indicates an input wobble signal inputted to a clock generating circuit. A wobble clock S₅ indicates a wobble clock outputted from a voltage controlled oscillator. A comparison signal S₆ indicates a comparison signal outputted from an orthogonal component generating means. A phase error detecting signal S₇ and a phase error signal S₈ indicate a phase error detecting signal outputted from a phase comparator and a phase error signal outputted from a loop filter, respectively.

FIG. 8 shows the embodiment of the present invention, and is a diagram showing waveforms of input/output signals of block in the clock generator means shown in FIG. 6 in the case in which the phase of the wobble clock is lagged 30 degrees from that of the wobble signal. A digital wobble signal S₉ indicates an input wobble signal inputted to the clock generating circuit. A wobble clock S₁₀ is a wobble clock outputted from the voltage controlled oscillator. A comparison signal S₁₁ is a comparison signal outputted from the orthogonal component generating means which is an orthogonal component generating section. A phase error detecting signal S₁₂ and a phase error signal S₁₃ indicates a phase error detecting signal outputted from the phase comparator and a phase error signal outputted from the loop filter, respectively.

FIG. 9 shows a conventional technology. A wobble signal S₁₄ indicates a wobble signal which is unsteady immediately after the start of a recording operation. A binarized signal S₁₅ indicates a signal obtained by binarizing the wobble signal. A wobble enable signal S₁₆ indicates a wobble enable signal which holds a PLL in a conventional optical disc apparatus.

### DESCRIPTION OF THE EMBODIMENTS

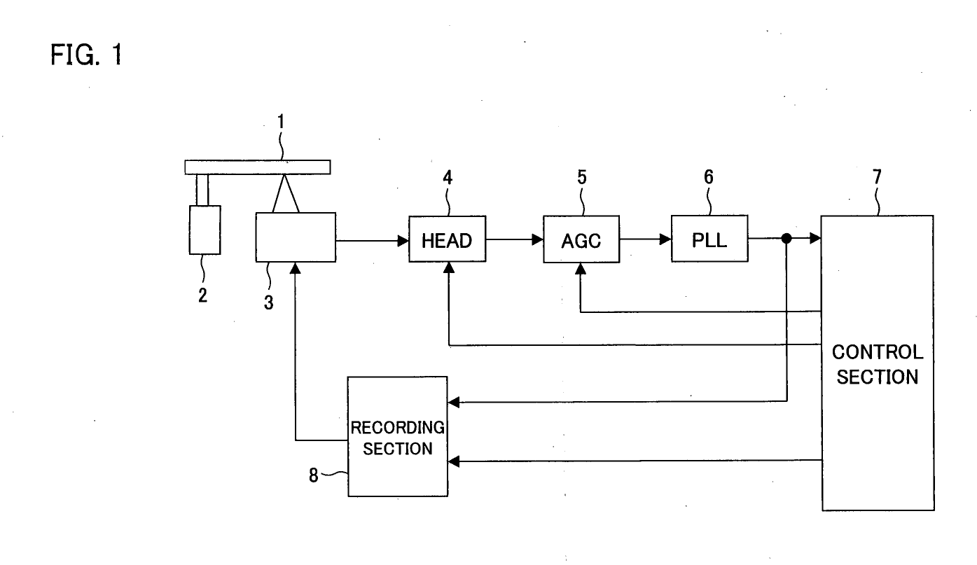

The following explains one embodiment of the present invention in reference to FIGS. 1 to 8.

FIG. 1 is a diagram showing an arrangement of substantial parts of an optical disc apparatus of the present embodiment.

Note that, as described in the conventional example, the wobbling is formed on the optical disc. Concrete examples of the optical disc are CD-R, CD-RW, DVD-R, DVD−RW, DVD+RW, etc.

As shown in FIG. 1, the optical disc apparatus includes a spindle motor 2, an optical pickup 3, an amplification head (HEAD, amplifier means) 4, an AGC (Automatic Gain Control, automatic gain control means) 5, a PLL (Phase Locked Loop, clock generator means) 6, a control section 7, and a recording section 8.

The spindle motor 2 is loaded with and rotates an optical disc 1. The optical pickup 3 irradiates the optical disc 1 with a laser light and receives a reflected light from the optical disc 1 so as to record/reproduce data. Moreover, the optical pickup 3 outputs to the amplification head 4 in the following stage an extracted wobble signal which is a signal read out from the wobbling on the optical disc 1.

The amplification head 4 receives the extracted wobble signal from the optical pickup 3, amplifies the extracted wobble signal with an amplification degree which is lower at the time of recording than that at the time of non recording, and then outputs the extracted wobble signal to the AGC 5 as an amplified wobble signal. The AGC 5 performs gain control of an amplitude of the amplified wobble signal inputted so that the amplitude reaches an amplitude target value determined by the control section 7. In this way, a gain control wobble signal is generated. The PLL 6 is constituted of a PLL circuit, and generates a wobble clock synchronized with the gain control wobble signal inputted.

The control section 7 controls the amplification head 4, the AGC 5, and the recording section 8. The recording section 8 causes the optical pickup 3 to record data to the optical disc 1.

The following explains a control operation for recording data to the optical disc 1. In response to an instruction for recording, the control section 7 outputs data to the recording section 8, and generates a recording command signal indicating a recording state and transmits the recording command signal to the amplification head 4. The recording command signal shows a high voltage value “H” in a non recording state, but shows a low voltage value “L” in the recording state. Receiving the recording command signal, the amplification head 4 switches the amplification degree for the wobble signal depending on whether the recording command is “enable” indicating the recording state or “disable” indicating the non recording state, so as to output the wobble signal. More specifically, in the case in which the recording command is “enable”, the extracted wobble signal is amplified with an amplification degree lower than that in the case in which the recording command is “disable”. That is, in the case in which the recording command is “enable”, the amplitude of the amplified wobble signal outputted to the following stage is lower than that in the case in which the recording command is “disable”.

The AGC 5 performs gain control so that the amplified wobble signal, whose amplitude changes depending on whether the optical disc apparatus is in the recording state or not, changes consecutively or stepwisely to reach a target amplitude (amplitude target value) determined in advance by the control section 7. Then, the PLL 6 utilizes the gain control wobble signal thus generated so as to generate the wobble clock. The recording section 8 synchronizes the data having been transmitted from the control section 7 with the wobble clock having been generated by the PLL 6, and then outputs to the optical pickup 3 the data having been transmitted from the control section 7.

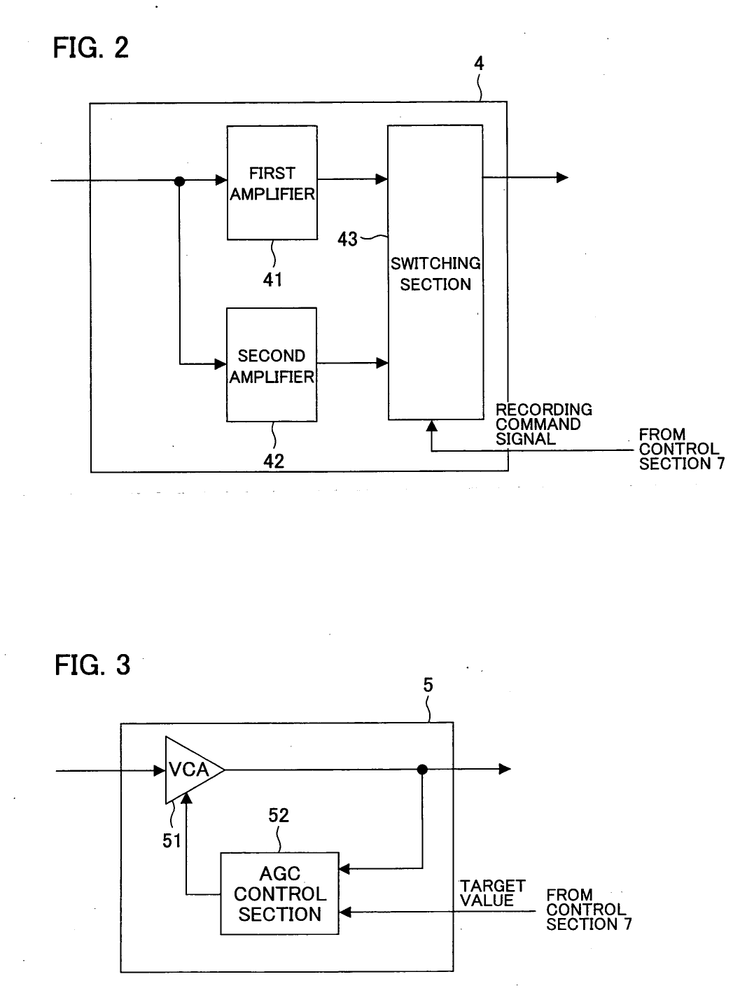

The following explains the amplification head 4 in reference to FIG. 2. FIG. 2 is a block diagram showing a specific arrangement of the amplification head 4 shown in FIG. 1.

The amplification head 4 includes a first amplifier 41, a second amplifier 42, and a switching section 43. Both the first amplifier 41 and the second amplifier 42 are amplifiers, and each amplifier amplifies the inputted wobble signal with a different amplification degree. Note that, if the amplification degree of the first amplifier 41 is α times and the amplification degree of the second amplifier 42 is β times, those amplification degrees are so set as to α>β. The extracted wobble signal is supplied to respective amplifiers, and two types of signals amplified with the respective amplification degrees are generated. Based on whether or not the recording command signal from the control section 7 is “enable” (‘L’) or “disable” (‘H’), the switching section 43 selects one of the above two types of signals as the amplified wobble signal to be outputted to the following stage. More specifically, in the case in which the recording command is “disable”, that is, in the non recording state, the switching section 43 selects the signal outputted from the first amplifier 41 having a higher amplification degree. In contrast, in the case in which the recording command is “enable”, that is, in the recording state, the switching section 43 selects the signal outputted from the second amplifier 42 having a lower amplification degree. Thus, the amplification head 4 changes the amplitude of the outputted amplified wobble signal depending on the state such as the recording state or the non recording state.

Note that, the amplification degree a is such an amplification degree (for example, 10 times) with which the PLL 6 can correct the phase error by a normal shift width. The amplification degree β is lower than the amplification degree a, and is such an amplification degree (for example, 1 time) that changes the shift width by which a certain degree of effect of correcting the phase error can be obtained. Moreover, it is preferable that α: β=substantially 10:1.

The following explains the AGC 5 in reference to FIG. 3. FIG. 3 is a block diagram showing a specific arrangement of the AGC 5 shown in FIG. 1.

The AGC 5 includes a voltage controlled amplifier (VCA) 51 and an AGC (Automatic Gain Control) control section 52. The voltage controlled amplifier 51 amplifies the amplitude of the inputted amplified wobble signal according to a preset voltage, and generates the gain control wobble signal. The AGC control section 52 (i) detects the amplitude of the signal outputted from the voltage controlled amplifier 51, (ii) detects an error according to the detected amplitude and a target value determined by the control section 7, and (iii) provides feedback of the error to the voltage controlled amplifier 51. The voltage controlled amplifier 51 changes the preset voltage based on the feedback of the error, and performs the gain control so as to correct the error. By arranging such a feedback loop in the AGC 5, the AGC 5 works so that an output amplitude converges the target value.

The following explains a method of gain control by the AGC 5.

A transfer property G(s) of a feedback loop in the AGC 5 is shown by the following formula. That is, a time period from a time point when the amplified wobble signal is changed to a time point when the gain control wobble signal becomes a steady state is defined by a first-order lag system shown by the following formula.
G(s)=1/(1+sT) (1)

Note that, T indicates a time constant showing a response speed of the gain control wobble signal with respect to an input of the amplified wobble signal, and s indicates a complex number.

Thus, the amplified wobble signal reaches the target value after the signal is changed (after a predetermined time has passed). As the predetermined time, for example, several milliseconds to several tens of milliseconds are sufficient. Moreover, because a bandwidth (shift width) of the PLL is affected by the amplitude target value, the target value is so determined in consideration of, for example, a gain of a VCO in the following stage that the bandwidth of the PLL becomes a desired value (for example, several kilohertz).

Moreover, a correction value (correction value of a voltage given from the AGC control section 52 to the voltage controlled amplifier 51) for the gain control is so set that the amplitude of the amplified wobble signal inputted to the AGC 5 is changed consecutively or stepwisely according to a response property shown by the formula (1). An indicial response A(t) at this time is shown by the following formula.
A(t)=1−exp(−t/T) (2)
Note that, the indicial response A indicates a property of following towards the target value, that is, the indicial response A indicates a relative value (amplitude value in the case in which the target amplitude is 1) of the amplitude of the gain control wobble signal after a time t has passed from an input of the amplified wobble signal.

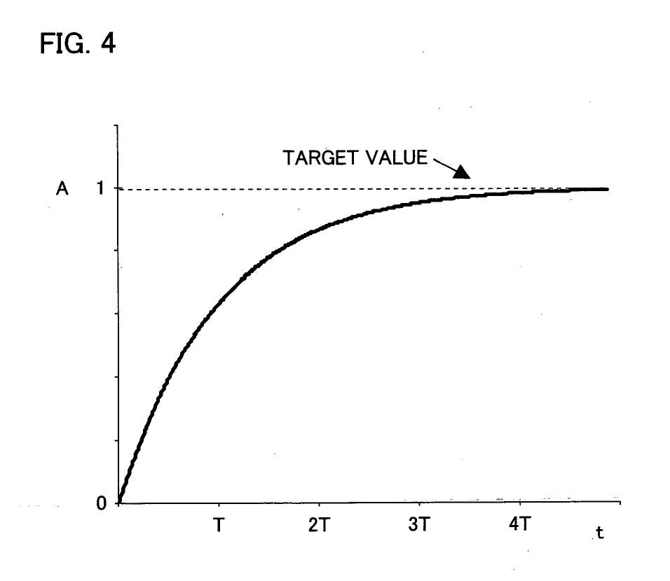

FIG. 4 shows the indicial response A(t) of the formula (2). As shown in FIG. 4, in a step response of a control system constituted of the first-order lag system, a time it takes to converge the target value changes according to the time constant T. That is, the time of the response can be controlled by determining the time constant T appropriately. Note that, needless to say, the time constant T can be determined in advance by the AGC control section 52 or the voltage controlled amplifier 51.

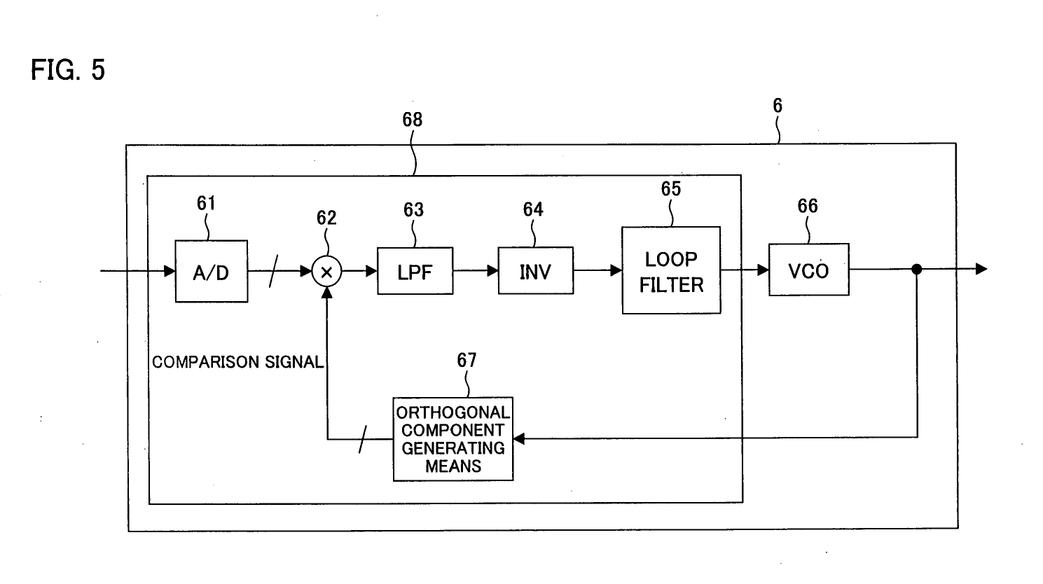

The following explains the PLL 6 in detail in reference to FIG. 5. FIG. 5 is a block diagram showing a specific arrangement of the PLL 6 shown in FIG. 1.

The PLL 6 includes a phase difference detector (phase difference detecting means) 68 and a voltage controlled oscillator (VCO, oscillator means) 66. The PLL 6 is a PLL circuit, and carries out a feedback control of the wobble clock and generates the wobble clock synchronized with the gain control wobble signal.

The phase difference detector 68 includes an A/D converter 61, a phase comparator (multiplication means) 62, a low pass filter (smoothing means) 63, a polarity inverter 64, a loop filter 65, and an orthogonal component generator (orthogonal conversion means) 67.

The A/D converter 61 converts an analog signal into a digital signal. That is, the A/D converter 61 converts the gain control wobble signal inputted to the PLL 6 as an analog signal into a digital wobble signal which is digitalized.

The phase comparator 62 is a circuit for outputting a phase error detecting signal which is a result obtained by multiplying (i) the digital wobble signal transmitted from the A/D converter 61 by (ii) a comparison signal outputted from the orthogonal component generator 67 described later.

The low pass filter 63 is a circuit which smoothes the phase error detecting signal outputted from the phase comparator 62, so as to output a phase error signal which is obtained by eliminating a high-frequency component from the phase error detecting signal. That is, the phase error detecting signal is a result obtained by multiplying the gain control wobble signal by the comparison signal, and includes a sum signal and a difference signal of the gain control wobble signal and the comparison signal. The low pass filter 63 eliminates the sum signal (high-frequency component) of the gain control wobble signal and the comparison signal from the phase error detecting signal. In this way, the low pass filter 63 outputs a smooth phase error signal which is the difference signal of the gain control wobble signal and the comparison signal.

The polarity inverter 64 is a circuit which inverts the polarity of the phase error signal outputted from the low pass filter 63 so as to generate a polarity inverted phase error signal. The polarity inverter 64 transmits the polarity inverted phase error signal to the voltage controlled oscillator 66 through the loop filter 65, so as to carry out negative feedback of the phase error signal.

The loop filter 65 outputs to the voltage controlled oscillator 66 the polarity inverted phase error signal generated by the polarity inverter 64. At this moment, a property of the loop filter 65 affects the bandwidth (shift width) and a dumping coefficient of the PLL 6 in a steady state.

The voltage controlled oscillator 66 generates the wobble clock synchronized with the wobbling on the optical disc 1. That is, the voltage controlled oscillator 66 changes the phase of the wobble clock according to the polarity inverted phase error signal transmitted from the loop filter 65, so that the wobble clock follows the frequency of the wobbling. The wobble clock outputted is multiplied so as to be outputted to the recording section 8 as the recording clock and also outputted to the orthogonal component generating means 67 for the feedback control.

The orthogonal component generating means 67 is a circuit which outputs a waveform signal as the comparison signal to the phase comparator 62 according to the wobble clock outputted from the voltage controlled oscillator 66, the waveform signal being orthogonal to the wobble clock. For example, in the case in which the waveform of the wobble clock outputted from the voltage controlled oscillator 66 is a cosine wave, the orthogonal component generating means 67 generates a sine wave as the comparison signal and outputs the sine wave to the phase comparator 62, because the sine wave is a waveform whose phase is advanced 90 degrees from the phase of the cosine wave. Note that, in the case in which the waveform of the wobble clock outputted from the voltage controlled oscillator 66 is the sine wave, the orthogonal component generating means 67 generates as the comparison signal the cosine wave whose phase is advanced 90 degrees from the phase of the sine wave.

The following explains waveforms of signals outputted from respective parts on the occasion of shifting from the non recording state to the recording state at a time point T4.

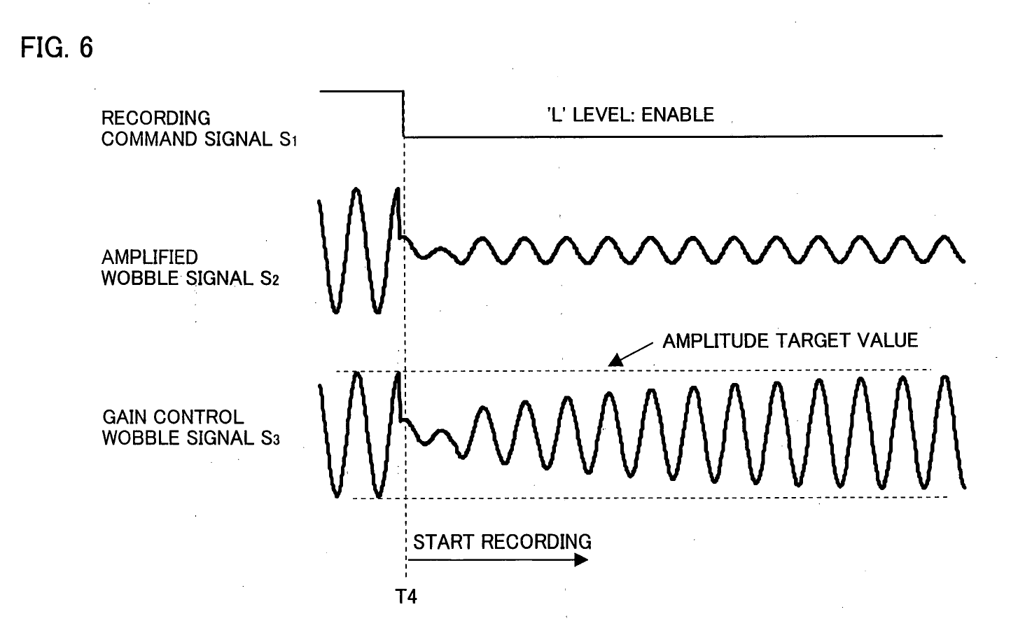

A waveform chart of a recording command signal S₁ in FIG. 6 indicates the recording command signal outputted from the control section 7 to the amplification head 4. In the non recording state, that is, before the time point T4, the recording command signal S₁ shows the high voltage level “H” (disable state). Meanwhile, in the recording state, that is, after the time point T4, the recording command signal S₁ shows the low voltage level “L” (enable state).

An amplified wobble signal S₂ in FIG. 6 indicates the amplified wobble signal outputted from the amplification head 4. As described above, the amplification head 4 determines which amplifier is to be used, according to the recording command signal. Until the time point T4 (non recording state), the signal outputted from the first amplifier 41 having the higher amplification degree is selected as the output signal (amplified wobble signal) of the amplification head 4 according to the disable state of the recording command signal. Because the recording state starts from the time point T4, the signal outputted from the second amplifier 42 having the lower amplification degree is selected as the output signal (amplified wobble signal) of the amplification head 4 according to the enable state of the recording command signal. Therefore, the amplitude of the amplified wobble signal before T4 is higher than that after T4.

A gain control wobble signal S₃ shown in FIG. 6 indicates the gain control wobble signal outputted from the AGC 5. The non recording state continues until the time point T4 and is in a steady state because the non recording state is lasting for a sufficient time, so that the amplitude of the gain control wobble signal is corrected by the AGC 5 so as to reach the target value. Immediately after the recording is started from the time point T4, the amplitude of the signal (amplified wobble signal S₂) inputted to the AGC 5 becomes low steeply as described above. This is because the amplification degree of the amplification head 4 changes according to the enable state of the recording command signal. Here, the AGC 5 performs the gain control by the feedback system so that the amplitude converges the amplitude target value. However, because this control shows a response of the first-order lag system as shown in FIG. 4, the amplitude immediately after the start of the recording is lower than the target value, but the amplitude gradually increases towards the target value.

It is preferable that the constant T be so set that a time when the gain control wobble signal outputted from the AGC 5 converges the target value is after a period during which the wobble signal immediately after the start of the recording is being unsteady. In the PLL 6 arranged as follows, if an input amplitude (that is, the amplitude of the gain control wobble signal) becomes low, an error detecting gain becomes low. Furthermore, a following bandwidth (the shift width of the follow) of the wobble clock, which is for following the extracted wobble signal, becomes low. On this account, immediately after the start of the recording, that is, in a period during which the wobble signal is being unsteady, the amplitude of the gain control wobble signal is lowered so as to be lower than the target value, so that the following bandwidth of in the PLL 6 is lowered. Therefore, even when the extracted wobble signal is unsteady, the wobble clock is less susceptible to the unsteady extracted wobble signal. Meanwhile, even though the error detecting gain is low, the PLL 6 keeps on causing the wobble clock to follow the extracted wobble signal. Therefore, this following is also carried out with respect to the influences caused by the disturbances applied immediately after the start of the recording. On this account, according to an arrangement of the present invention, the wobble clock is less susceptible to the unsteady wobble signal, and can follow the wobble signal even when the disturbance, the decentering, or the like occurs.

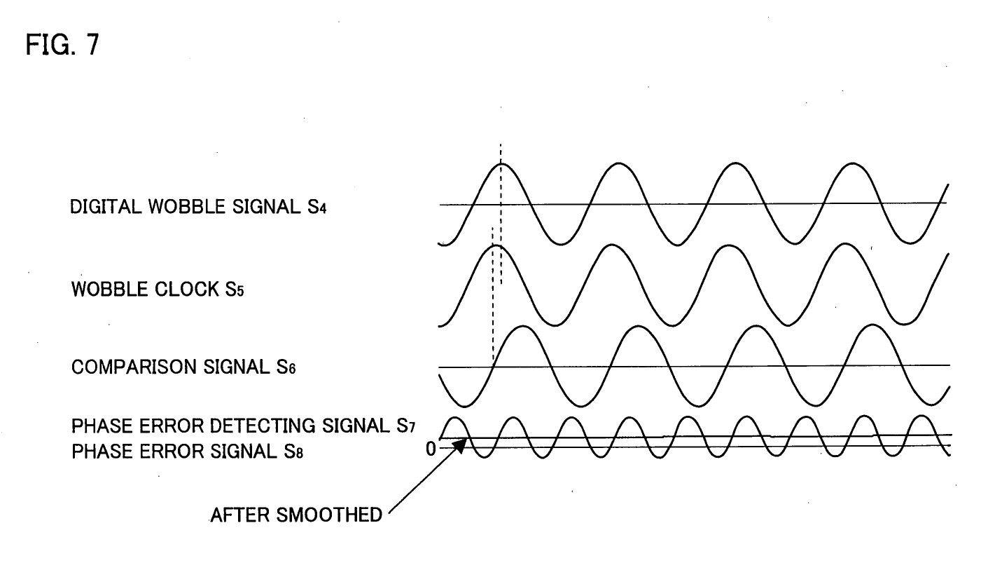

In reference to the waveform shown in FIG. 7, the following explains an operation of correcting the wobble clock in the PLL 6.

A digital wobble signal S₄ shown in FIG. 7 indicates a waveform of the digital wobble signal which is inputted to the PLL 6 after being subjected to the gain control, and digitalized by the A/D converter 61. Note that, by way of example, the waveform of the digital wobble signal is the cosine wave in the present embodiment, but is not limited to this and may be the sine wave, or the like.

The digital wobble signal is compared with the comparison signal by the phase comparator 62. The following explains a method of generating the comparison signal. A wobble clock S₅ shown in FIG. 7 indicates a waveform of the wobble clock outputted from the voltage controlled oscillator 66. In FIG. 7, by way of example, it is assumed that the phase of the wobble clock outputted from the voltage controlled oscillator 66 is advanced 30 degrees from the phase of the digital wobble signal (i.e. there is an error between the phases of the wobble clock and the digital wobble signal). The wobble clock is outputted from the voltage controlled oscillator 66 to the orthogonal component generating means 67, and is converted into a comparison signal whose phase is advanced 90 degrees as shown by a comparison signal S₆ in FIG. 7.

The comparison signal is outputted to the phase comparator 62, and the phase comparator 62 multiplies the digital wobble signal S₄ shown in FIG. 7 by the comparison signal S₆ shown in FIG. 7, so as to output the phase error detecting signal S₇ shown in FIG. 7. The phase error detecting signal has a waveform corresponding to the phase difference between the digital wobble signal and the comparison signal. In this example, because the wobble clock is advanced 30 degrees from the digital wobble signal, the wobble clock shifts from 0V in a +direction by a value corresponding to 30 degrees.

The low pass filter 63 smoothes the phase error detecting signal by eliminating the high-frequency component. In this way, the phase error detecting signal becomes a phase error signal S₈ which is shown by a heavy line in FIG. 7 and has a +voltage. That is, in the case in which the phase of the wobble clock outputted from the voltage controlled oscillator 66 is advanced from the phase of the digital wobble signal, the phase error signal obtained by smoothing the phase error detecting signal has a positive value.

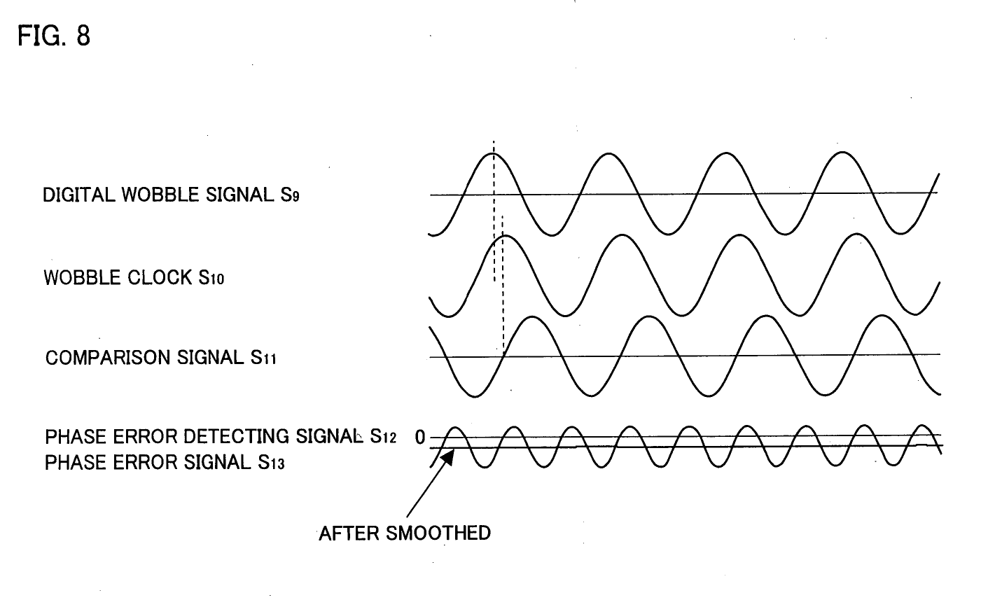

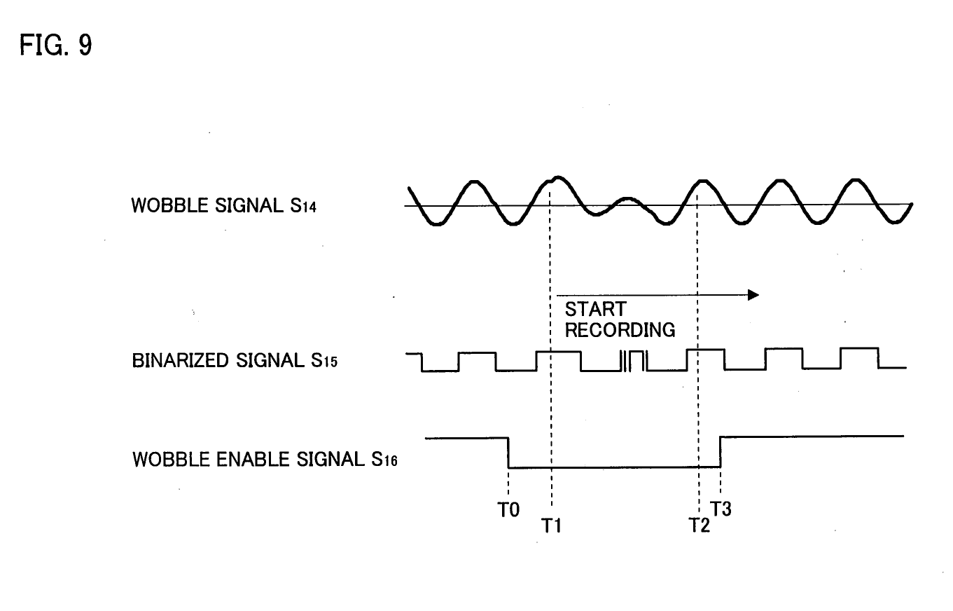

Meanwhile, in the case in which the phase of the wobble clock outputted from the voltage controlled oscillator 66 is lagged 30 degrees from the phase of the digital wobble signal, that is, in the case in which the digital wobble signal is a digital wobble signal S₉ in FIG. 8 and the wobble clock is a wobble clock S₁₀ in FIG. 8, the comparison signal becomes a comparison signal S₁₁ shown in FIG. 8, and the phase error detecting signal shifts in a −direction like a phase error detecting signal S₁₂ shown in FIG. 8. In this case, the phase error signal obtained by smoothing the phase error detecting signal has a negative value as shown by a heavy line indicating a phase error signal S₁₃ in FIG. 8.

The polarity of the phase error signal thus smoothed is inverted by the polarity inverter 64, and then inputted to the voltage controlled oscillator 66 through the loop filter 65. Then, the voltage controlled oscillator 66 corrects the phase lag of the wobble clock according to the polarity-inverted phase error signal. Thus, the voltage controlled oscillator 66 newly outputs the wobble clock which has followed the digital wobble signal.

As such, the voltage controlled oscillator 66 is so controlled as to generate the wobble clock synchronized with the digital wobble signal. Therefore, the waveform of the wobble clock outputted in this example becomes the cosine wave naturally.

Note that, a state in which the PLL circuit arranged in the PLL 6 is in lock indicates a state in which a relation between the phases of the digital wobble signal S₄ shown in FIG. 7 and the wobble clock S₅ shown in FIG. 7 is constant.

The following explains the above-described phase error detection by using mathematical formulas.

First, the digital wobble signal (cosine wave) outputted from the A/D converter 61 can be shown by the following formula.
Digital wobble signal=A×cos 2πft (3)

Note that, f indicates a frequency corresponding to a single frequency portion of the wobbling, t indicates a time, and A indicates an amplitude of the wobble signal inputted. Then, the phase of the wobble clock outputted from the voltage controlled oscillator 66 is advanced by 0 from the phase of the wobble signal inputted to the PLL 6 (i.e. there is an error between the phases of the wobble clock and the wobble signal).

Because the wobble signal inputted to the PLL 6 shows the cosine wave as is assumed by the formula (3), the wobble clock outputted from the voltage controlled oscillator 66 is shown by the following formula.
Wobble clock=cos(2πft+θ) (4)
(−180°<θ≦180°)

Moreover, because the orthogonal component generating means 67 outputs the comparison signal which is advanced 90 degrees from the wobble clock, the comparison signal is shown by the following formula.
Comparison signal=sin(2πft+θ) (5)
(−180<θ≦180°)

Further, because the phase comparator 62 outputs a result obtained by multiplying the formula (3) by the formula (5), the phase error detecting signal outputted from the phase comparator 62 is shown by the following formula.

$$\begin{matrix}Phase error detecting signal = A \times cos 2 π ft \times sin ( 2 π ft + θ ) \\ = ( A / 2 ) \times \{ sin ( 4 π ft + θ ) + sin θ \}\end{matrix} \qquad ( 6 )$$

The low pass filter 63 outputs the phase error signal which is obtained by eliminating the high-frequency component from the phase error detecting signal. That is, the high-frequency component is eliminated from the formula (6), so that the first term of the formula (6) can be ignored. On this account, the phase error signal outputted from the low pass filter 63 is shown by the following formula.
Phase error signal=(A/2)×sin θ (7)
The formula (7) indicates the phase error detected.

Note that, the phase error signal is in proportion to a sine value of θ. Therefore, the phase error signal is a positive value in the case of 0°<θ≦180° (advanced), and is a negative value in the case of −180°≦θ<0° (lagged). That is, in the case in which the phase of the wobble clock outputted from the voltage controlled oscillator 66 is advanced from the phase of the digital wobble signal, the phase error signal is a positive value. Meanwhile, in the case in which the phase of the wobble clock outputted from the voltage controlled oscillator 66 is lagged from the phase of the digital wobble signal, the phase error signal is a negative value. Therefore, based on the phase error signal (positive/negative), it is possible to find out whether the phase of the wobble clock is advanced or lagged. On the basis of this, it is possible to adjust the phase of the wobble clock.

Moreover, the phase error signal is in proportion to the amplitude A of the digital wobble signal. Therefore, a ratio for correcting the phase of the wobble clock (that is, the shift width of the follow) is determined according to the amplitude of the digital wobble signal. On this account, based on the gain control wobble signal whose amplitude is low immediately after the start of the recording but reaches the target value after a predetermined time (in a period during which the extracted wobble signal is being unsteady), the ratio for correcting the wobble clock is low at first but gradually increases.

Therefore, immediately after the start of the recording, that is, in a period during which the wobble signal is being unsteady, the amplitude of the gain control wobble signal is lower than the target value. On this account, the shift width of the follow in the PLL 6 is low, and the wobble clock becomes less susceptible to the unsteady extracted wobble signal. Meanwhile, the PLL 6 keeps on causing the wobble clock to follow the extracted wobble signal at a low ratio. Therefore, this follow is carried out with respect to the influences caused by the disturbances immediately after the start of the recording. On this account, according to the arrangement of the present invention, the wobble clock is less susceptible to the unsteady wobble signal immediately after the start of the recording, and can follow the wobble signal in part even when the disturbances, decentering, or the like occurs.

Further, because the shift width of the follow of the extracted wobble signal by the wobble clock changes slowly, the PLL for reproduction can follow easily.

With the above arrangement, it is possible to easily detect the phase error, the polarity of the phase error signal detected is inverted by the polarity inverter 64, and the voltage controlled oscillator 66 receives the feedback of the polarity-inverted phase error signal. In this way, the feedback control is carried out so that the phase difference between the wobble clock outputted from the voltage controlled oscillator 66 and the digital wobble signal converges zero.

The present invention is not limited to the embodiments above, but may be altered within the scope of the claims. An embodiment based on a proper combination of technical means disclosed in different embodiments is encompassed in the technical scope of the present invention.

Moreover, the present invention may be arranged as follows.

An optical disc apparatus of the present invention may include (i) the amplifier means which can set a different amplification degree in the case of recording and non recording, the amplification degree being used for the wobble signal read out from the wobbling formed on the optical disc, (ii) the automatic gain control means which performs the gain control so that the amplitude of the wobble signal amplified reaches a predetermined target value, and (iii) the clock generator means which is so arranged that the bandwidth for following the gain control wobble signal changes in proportion to the amplitude of the gain control wobble signal outputted from the automatic gain control means.

The amplifier means may be so arranged that the amplification degree used at the time of recording is lower than that used at the time of non recording.

The automatic gain control means may be so arranged that the gain control is carried out with respect to the input signal so that the amplitude of the input signal reaches the target value in a certain time constant, the certain time being longer than a period during which the waveform of the inputted wobble signal is being unsteady after switching from the non recording state to the recording state.

The clock generator means may be so arranged as to include (i) an oscillator means which generates the wobble clock synchronized with the wobble signal read out from the wobbling formed on the optical disc, (ii) an orthogonal conversion means which outputs the comparison signal having a waveform orthogonal to a waveform of the wobble clock, (iii) a multiplication means which multiplies the comparison signal by the wobble signal, and (iv) a smoothing means which smoothes the result obtained by the above multiplication and outputs the smoothed result as the phase error signal.

The oscillator means may be so arranged as to control the frequency of the wobble clock according to the phase error signal.

The clock generator means receives the wobble signal read out from the wobbling formed on the optical disc and generates a wobbling clock synchronized with the wobble signal, and the clock generator means may be so arranged as to include a PLL which carries out a feedback control of a waveform signal orthogonal to the wobbling clock.

An optical disc apparatus of the present invention includes the clock generator means which (i) is less susceptible to the unsteady wobble signal generated immediately after switching from an operation other than the recording (the reproducing operation, etc.) to the recording operation and (ii) follows the wobble signal even when the disturbance, such as the decentering, occurs. Therefore, the present invention is applicable to an optical disc apparatus which can carry out the recording, and more specifically to an optical disc recording/reproducing apparatus for CD-R, CD-RW, DVD-R, DVD−RW, DVD+RW, etc.

Moreover, the optical disc apparatus of the present invention is characterized in that the automatic gain control means stepwisely performs the gain control of the amplified wobble signal.

According to this, the amplitude of the gain control wobble signal outputted to the clock generator means in the following stage increases consecutively in a period starting from the start of the recording until a time when the amplitude reaches the target value. Therefore, in this period, the ratio for correction (following bandwidth) of the clock generator means also increases consecutively. On this account, immediately after the start of the recording, that is, in a period during which there is a high possibility that the extracted wobble signal is being unsteady, the frequency is corrected at a low ratio, and the shift width for correction increases consecutively as time passes.

The frequency of occurrence of unsteadiness of the extracted wobble signal becomes the highest immediately after the start of the recording, and gradually decreases. According to the present invention, the wobble clock is corrected little by little when the frequency of occurrence is high, and the ratio for correction is increased as the frequency of occurrence decreases. That is, the clock generator means achieves an effect in which an unintended following with respect to the unsteadiness of the wobble signal at the time of recording is reduced, but the following is increased as time passes.

Further, the gain of the amplified wobble signal is controlled stepwisely and the gain control wobble signal is changed slowly. In this way, the phase of the wobble clock changes slowly, and it is easy for the PLL for reproduction data to follow.

In addition to the above arrangement, the optical disc apparatus of the present invention is characterized in that the automatic gain control means performs the gain control so that the amplitude of the gain control wobble signal reaches the target value after a period during which the waveform of the extracted wobble signal is being unsteady when switching from the operation other than the data recording to the data recording operation.

According to the above arrangement, the unsteadiness of the wobble signal occurs immediately after the start of the recording, but does not occur at a time when the amplitude converges the target value by the gain control. In other words, while the wobble signal is unsteady, the amplitude of the gain control wobble signal is lower than the target value. Therefore, while the wobble signal is unsteady, the amplitude of the gain control wobble signal is lower than that in a steady state. On this account, the shift width (following bandwidth) of the phase of the clock generator means can be lower than that in a steady state. As a result, the wobble clock is less susceptible to the unsteadiness of the wobble signal.

In addition to the above arrangement, the optical disc apparatus of the present invention is characterized in that (i) the clock generator means includes (a) an oscillator means which generates the wobble clock having followed the extracted wobble signal and (b) a phase error detector means which generates the phase error signal by comparing the wobble clock with the gain control wobble signal generated by the automatic gain control means, and (ii) the oscillator means corrects the phase error according to the phase error signal so as to generate the wobble clock having followed the extracted wobble signal.

According to the above arrangement, the oscillator means can generate the wobble clock which always follows the extracted wobble signal.

Moreover, the phase error detector means is characterized by generating the phase error signal by using the comparison signal whose waveform is orthogonal to the waveform of the wobble clock.

According to this, the phase error of the wobble clock can be corrected satisfactorily.

Moreover, the phase error detector means is characterized by including (i) an orthogonal conversion means which outputs the comparison signal whose waveform is orthogonal to the waveform of the wobble clock, (ii) a multiplication means which multiplies the comparison signal by the gain control wobble signal so as to output the phase error detecting signal, and (iii) a smoothing means which smoothes the phase error detecting signal so as to output the phase error signal.

The orthogonal conversion means outputs the comparison signal whose waveform is orthogonal to the waveform of the wobble clock outputted from the oscillator means. For example, the wobble clock having the sine wave corresponds to the comparison signal having the cosine wave, and the wobble clock having the cosine wave corresponds to the comparison signal having the sine wave. Further, the multiplication means multiplies the comparison signal by the gain control wobble signal so as to output the phase error detecting signal. Because the comparison signal is 90 degrees out of phase (orthogonal) from the wobble clock, the phase error detecting signal obtained by multiplying the gain control wobble signal by the comparison signal includes (A/2)×sin θ which is the sine value (note that, θ indicates the phase difference between the wobble clock and the wobble signal, and A indicates an amplitude of the gain control wobble signal inputted.). Therefore, by smoothing the value obtained by multiplication and eliminating the sum signal (high-frequency component) by the smoothing means, it becomes possible to obtain the phase error signal shown by the sine value.

That is, as described above, the present invention achieves an effect in which the clock generator means can obtain the phase error signal which is in proportion to the amplitude of the gain control wobble signal and is based on the phase error between the wobble clock and the gain control wobble signal.

Note that, because the phase error signal is the sine value, the phase error signal is a positive value in the case of 0<θ≦180°, and is a negative value in the case of −180°≦θ<0°. Therefore, in the case in which the phase error signal is the positive value, it is possible to judge that the phase of the wobble clock is advanced from that of the wobble signal. In the case in which the phase error signal is the negative value, it is possible to judge that the phase of the wobble clock is lagged from that of the wobble signal.

Therefore, by correcting the frequency of the wobble clock with a ratio corresponding to the positive/negative voltages of the phase error signal and those absolute values, it becomes possible to achieve an effect in which the wobble clock can follow the gain control wobble signal having the same phase as the extracted wobble clock.

As described above, the optical disc apparatus of the present invention includes (i) the amplifier means for amplifying the extracted wobble signal at the time of recording with the amplification degree which is lower than that at the time of non recording, the extracted wobble signal being read out from the wobbling formed on the optical disc, (ii) the automatic gain control means for controlling the gain so that the amplitude of the amplified wobble signal amplified by the amplifier means reaches the predetermined target value after a certain time has passed, so as to output the gain control wobble signal, and (iii) the clock generator means for generating the wobble clock which is so corrected by the shift width proportional to the amplitude of the gain control wobble signal as to follow the extracted wobble signal.

With this, it is possible to achieve an effect in which (i) an adjustment of the frequency of the wobble clock is less susceptible to the unsteady extracted wobble signal generated at the time of switching from the time of non recording to the time of recoding, (ii) the wobble clock can follow the extracted wobble signal, and (iii) the wobble clock can follow a change of the wobble signal in the other periods in the same way as before.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. An optical disc apparatus comprising:
an amplifier means for amplifying an extracted wobble signal at a time of data recording with an amplification degree lower than that at a time of non data recording, the extracted wobble signal being generated based on a wobbling formed on an optical disc;
an automatic gain control means for performing gain control so that an amplitude of the amplified wobble signal amplified by the amplifier means at the time of data recording reaches a predetermined target value after a predetermined time has passed from a time point of switching from the time of non data recording to the time of data recording, so as to output a gain control wobble signal; and
a clock generator means for generating a wobble clock which is so corrected by a shift width proportional to the gain control wobble signal as to follow the extracted wobble signal.

2. The optical disc apparatus as set forth in claim 1, wherein:
the amplifier means includes a first amplifier for amplifying the extracted wobble signal and a second amplifier having an amplification degree lower than that of the first amplifier,
at the time of non data recording, the wobble signal amplified by the first amplifier is adopted as the amplified wobble signal, and
at the time of data recording, the wobble signal amplified by the second amplifier is adopted as the amplified wobble signal.

3. The optical disc apparatus as set forth in claim 1, wherein the automatic gain control means performs the gain control so that the amplified wobble signal changes stepwisely.

4. The optical disc apparatus as set forth in claim 1, wherein the automatic gain control means includes a feedback loop and causes the amplitude of the outputted gain control wobble signal to converge the target value.

5. The optical disc apparatus as set forth in claim 1, wherein the automatic gain control means performs the gain control so that the amplitude of the gain control wobble signal reaches the target value after a period during which the waveform of the extracted wobble signal is being unsteady after a time point of switching from an operation other than a data recording operation to the data recording operation.

6. The optical disc apparatus as set forth in any one of claims 1 to 5, wherein:
the clock generator means includes:
an oscillator means for generating the wobble clock which has been caused to follow the extracted wobble signal; and
a phase error detector means for comparing the wobble clock with the gain control wobble signal generated by the automatic gain control means, so as to generate a phase error signal, and
the oscillator means generates the wobble clock which is caused to follow the extracted wobble signal on account of a correction of a phase error according to the phase error signal.

7. The optical disc apparatus as set forth in claim 6, wherein the phase error detector means generates the phase error signal by using a comparison signal whose waveform is orthogonal to the waveform of the wobble clock.

8. The optical disc apparatus as set forth in claim 7, wherein the phase error detector means includes:
an orthogonal conversion means for outputting the comparison signal whose waveform is orthogonal to the waveform of the wobble clock;
a multiplication means for multiplying the comparison signal by the gain control wobble signal so as to output the phase error detecting signal; and
a smoothing means for smoothing the phase error detecting signal so as to output the phase error signal.
